(19) United States
(12) Patent Application Publication
(10) Pub. No.: US 2008/0250020 A1
(43) Pub. Date: Oct. 9, 2008

(54) ONTOLOGICAL REPRESENTATION OF KNOWLEDGE

(75) Inventor: Suresh Madhavan, Foster City, CA (US)

Correspondence Address: PERKINS COIE LLP, P.O. BOX 1208, SEATTLE, WA, 98111-1208, US

(73) Assignee: PointCross, Inc, Foster City, CA (US)

(21) Appl. No.: 12/062,485

(22) Filed: Apr. 3, 2008

Related U.S. Application Data
(63) Continuation-in-part of application No. 09/765,993, filed on Jan. 20, 2001, now abandoned.

(51) Int. Cl. G06F 17/30

(52) U.S. Cl. 707/9; 707/103 R; 707/E17.055

(57) ABSTRACT

A technique provides for an ontological representation of knowledge included in one or more contexts. A system and method based on the technique allows the creation, editing, and evolution of the ontology in the normal course of business as entities interact and communicate. Agents acting on behalf of contexts control the storage and linking of objects included in the ontology. Tree data structures and databases can be used to represent and store contexts, objects, roles, and taxonomies. Objects can be linked to other objects through context. Further, the contexts can be accessed through an authorization and accountability model.

### CROSS-REFERENCE TO RELATED APPLICATIONS

This application is a continuation-in-part application and claims priority to U.S. patent application Ser. No. 09/765,993, filed Jan. 20, 2001 entitled “Integrated Project Office” by Suresh Madhavan, which is incorporated herein by reference.

### BACKGROUND

Individuals, software agents, corporations and other entities often collaborate to further a business interest. Large global businesses are typically engaged in knowledge intensive, decision centric activities and can be described in terms of three types of organizations that exist contemporaneously—formal, real, and informal.

The formal organization describes the structure of a business hierarchy using titles that are given to individuals and entities. A hierarchical structure can relate the entities to each other in terms of subordinate and supervisory relationships. Formal organizations are designed to ensure implementation of business policies and compliance with regulations. Such a hierarchy establishes strategy and provides common services to an entire company. For example, value generation in a transactional (such as banking) or transformational (such as manufacturing) company is often completed within the formal organization.

Real organizations of entities are continuously spawned to perform projects each having a business purpose for existing, for example, construct a new building, develop an advertising campaign, hire a new employee. For each such project a context exists relating the roles of entities associated with the context in accordance with the demands of the strategy defined by the formal organization. The executed projects can be ad hoc or they may be process driven. Each such project can be a very small assignment or can be a large heavily choreographed program of sub-projects executed by a global team of hundreds or thousands of people.

Informal organizations include unstructured networks of people. People form social relationships within a business and seek assistance from each other. Such individuals do not have formal authority or accountability to one another. However a common interest links them in and directs their efforts to support the well being of the business. Individuals in informal organizations contribute knowledge and experience with each other. Mentoring is an important aspect of these relationships. Informal organizations are very important for distributing knowledge and creativity through the individuals in the business organization.

Individuals working together within real, and informal organizations are often disconnected and produce a large volume of documents, communications and other objects that require organization. Attempts to capture the structures of real and informal organizations has been hampered by the elusive nature of the real and informal organizations. Some individuals are unaware of objects created by other individuals working on the same projects. Other individuals are unable to acquire the objects that they need without directly contacting the individuals possessing the objects. Further, the objects are often reproduced unnecessarily wasting space and requiring larger and larger storage systems.

Further, security of objects is constantly in question as individuals have the power to provide objects to each other, but should not disclose objects to individuals lacking authority. Such disclosure risks exposure of sensitive material to unauthorized individuals.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

In accordance with the techniques described herein, an ontological representation of knowledge captures entities, their roles, and objects in one or more business contexts. The ontological representation of knowledge allows the creation, editing, and evolution of the ontology in the normal course of business as individuals interact and communicate. Together all business contexts of an organization describe all of the projects that are ongoing in the business organization. Real and informal organizations are captured and stored by context agents, or surrogates of the contexts. While the context is a conceptual representation of a business project, the agents are actors able to manage objects for the context. Such agents can provide objects to one or more individuals performing roles within the context. At times, the agents may provide objects to individuals based on the roles of the individuals, even without requests from the individuals, such as to comply with laws regulating the business organization. As only some individuals have authorization to see some objects in a business organization, security of the objects is managed by the agents to prevent the viewing of objects by unauthorized individuals. Such agents operate as a group collectively to manage all of the objects in all of the contexts of the business organization.

### BRIEF DESCRIPTION OF THE DRAWINGS

FIG. 1 depicts a diagram of an example of an ontological context agent managing objects transmitted by n different business entities.

FIG. 2 depicts a diagram of an example of an ontological context agent using organizational management information.

FIG. 3 depicts an example of an ontological context agent relating objects to contexts and entities using a taxonomy tree.

FIG. 4 depicts a flowchart of an example of a method for making an object available to an entity having a role in a context without a request from the entity for the object.

FIG. 5 depicts a diagram of an example of an ontological context agent coupled to a context node, an entity database, a role database, and object storage.

FIG. 6 depicts a diagram of an example of a plurality of agents acting on behalf of contexts.

FIG. 7 depicts a diagram of an example of an ontological representation of knowledge of a business organization.

FIG. 8 depicts a diagram of an example of a computing system typical of any one of the computing systems discussed herein.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

In accordance with the techniques described above, real projects can be defined in terms of a structured organization defined by roles using an organization breakdown structure (OBS). Each role is delegated a level of responsibility. E.g., a project manager can be accountable to the formal organization for the project progress with regard to the business purpose. A project can have a set of expected deliverables the, e.g. creation, modification, or destruction of which achieves the purpose of the project. Individuals are assigned to roles in the real organization. Real projects have a minimum of a single context which is the purpose of the project itself; or they may include one or more hierarchically organized context nodes in a context tree. Each such node can represent a purpose such as a specific task, or a deliverable. Such a hierarchical organization is a context tree. Each context in a tree is linked to objects created in furtherance of the business purpose of the context. Each context is also linked to the roles in the OBS that may act on behalf of the context. The context is therefore a self-contained unit of business activity. The context is a matter for a legal department or organization. It is a task in a project; or a component in a design; or a subsection in a complex contract.

A real organization includes a collection of contexts associated with real projects. This collection may include independent disconnected real projects; as well as interconnected real projects where individual contexts of one project tree may be linked or connected to the context in another project tree. Links connect the contexts of one tree to another to represent communications, dependencies, workflow relationships, definitions, assignments or data flows. These links can be built explicitly by users; or they can be automatically created by automated process workflows. The resulting structure of interconnected trees form the ontology of the business and it represents the knowledge state of the business.

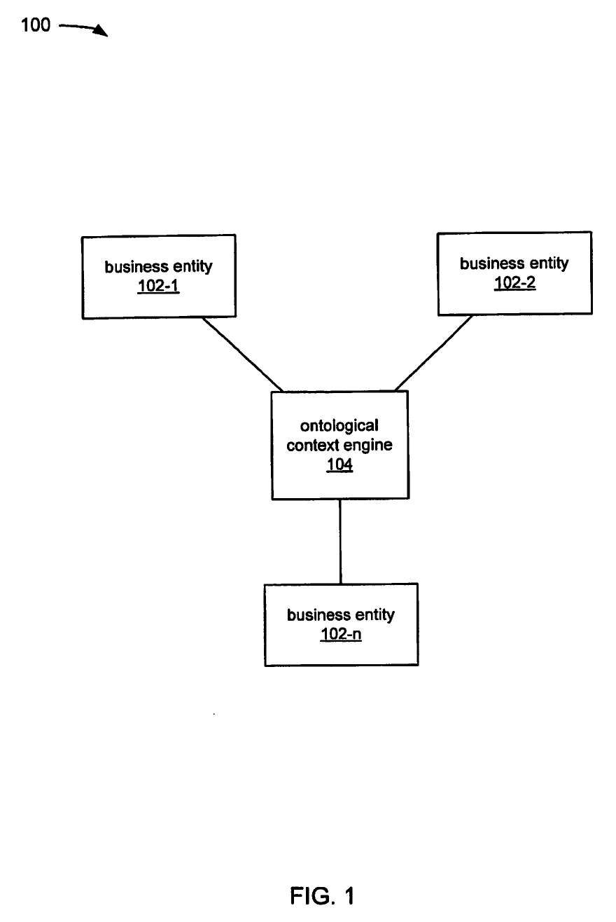

FIG. 1 depicts a diagram of an example of an ontological context agent managing objects transmitted by n different business entities. FIG. 1 includes business entity 102-1, business entity 102-2, and business entity 102-n (collectively business entities 102) and ontological context engine 104.

In the example of FIG. 1, business entities 102 can be individuals, automated processes executing in hardware, or corporations acting through their representatives. The business entities 102 produce new objects or modify existing objects in furtherance of a business purpose. The objects can be emails, documents, presentations, and any other known or convenient objects. The business entities 102 transmit and receive objects, typically collaborating with each other to further a business purpose.

The ontological context engine 104 includes one or more context agents storing retrieving and linking objects to entities on behalf of contexts. An engine typically includes a processor and a memory, the memory storing instructions for execution by the processor to perform the function of the engine. Data structures such as trees include links to objects and can be used to relate the objects to the entities that create and use the objects. Objects are stored and retrieved by the ontological context engine. The ontological context engine executes instructions to make objects available to entities requiring the objects. At times, the ontological context engine 104 provides objects to an entity automatically such as where the entity is associated with a context that is associated with the objects.

In the example of FIG. 1, in operation, the business entities 102 produce objects relevant to a business purpose of the context with which the businesses entities 102 are associated. The business entities 102 transmit and receive the objects with each other via the ontological context engine 104. The ontological context engine 104 stores the objects and links the business entities 102 to the objects. As needed, the ontological context engine 104 provides objects to entities requiring the objects. The ontological context engine 104 checks business entities 102 for authority to view the objects. At times, the ontological context engine links one or more of the business entities 102 to objects. Entities playing roles in contexts for the business entities 102 can use the objects, or have a need to know of the objects.

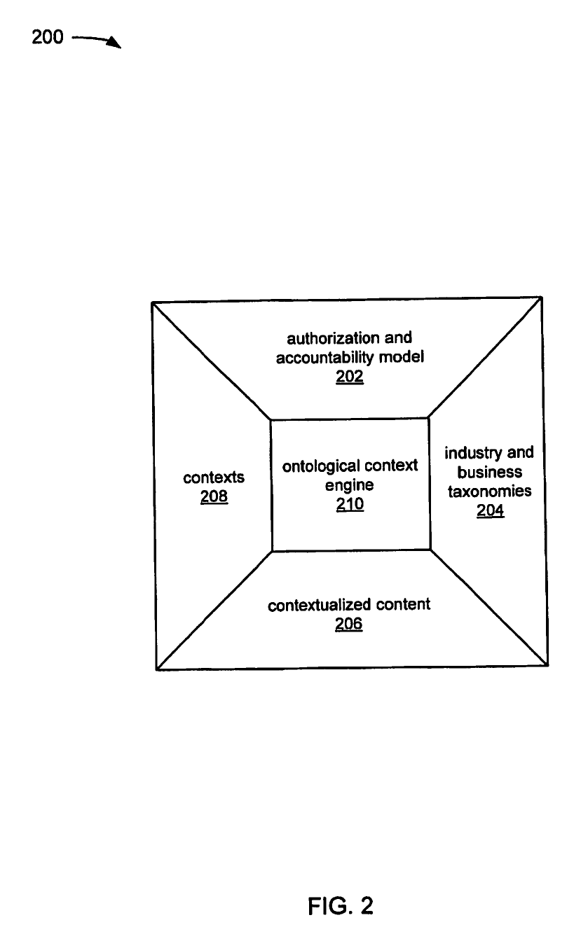

FIG. 2 depicts a diagram of an example of an ontological context agent. FIG. 2 includes authorization and accountability model 202, industry and business taxonomies 204, contextualized content 206, contexts 208, and ontological context engine 210.

In the example of FIG. 2, authorization and accountability model 202 defines a secure environment for objects stored by the ontological context engine 210. The authorization and accountability model 202 incorporates security in compliance with policies and regulatory statutes in managing business information, privacy, and sensitivity concerns. In accordance with the authorization and accountability model 202, the objects and entities are assigned security classifications. Entities are a assigned a security classification that is specific to the business purpose of a context with which the entity is associated with. Access to objects by entities performing roles is explicitly defined for a context. Entities can be provided access to the objects by comparing their security classification with that of the objects. An example of a security classification is a need to know of an object for an entity assuming a role. Entities are not allowed to discover objects without authorization. Such authorization is verified for each search result displayed.

In the example of FIG. 2, the industry and business taxonomies 204 include relationships between one or more terms, titles, names or other identifiers to a role performed by the holder of the terms, titles, names or other identifiers. The many relationships can be used to identify roles performed by entities. In a non-limiting example, a taxonomy tree can be defined to include synonyms for roles included in a context. The industry and business taxonomies 204 include ad hoc “folksonomies” or lists of terms added to meet the needs of a process or local lingo to provide attribution and meta-tags for the contexts, roles and people working on these contexts. These industry and business taxonomies 204 can be referred to as domain trees. Industry and business taxonomies 204 can be used to attribute data, and content to entities performing roles.

In the example of FIG. 2, contextualized content 206 includes objects associated with contexts. Such objects include disparate types of structured and unstructured data along with their metadata. Examples of objects include documents, email, datasets, metadata around maturing entities within processes, business events and decisions, and streaming real time data. New object types can be added as called for by the business processes and solutions. Such objects can be stored in a database implementing context storage. Meta-data can be represented using files formatted to the extensible markup language (XML). Such meta-data can be used to create links between the objects and the contexts. One or more objects are captured into contextual structures organized along business functions, projects, and processes. For example, email, documents, presentations, and other information linked to a context are included in contextualized content 206.

In the example of FIG. 2, each context of contexts 208 is linked to relevant objects, roles, and assignments of entities to roles. A “context” can be a virtual container including a representation of an ongoing project having a business purpose. Such a representation can be expressed as a database record linked to one or more other databases. Objects can be stored in the database, or can be directly linked to the context.

In the example of FIG. 2, the ontological context engine 210 organizes contexts, objects, and entities into structures that model the real world business. The engine includes an agent for each context. Each agent can perform one or more actions. As the ontological context agents make up the ontological context engine 210, the actions of the agents are the actions of the ontological context engine 210.

In the example of FIG. 2, in operation, the ontological context engine 210 links contexts to other contexts and structures to create a real time representation of the state of knowledge of the enterprise and the relevance of its information. The ontological context engine 210 uses the industry and business taxonomies 204 to assign roles to entities operating in the context. The ontological context engine 210 continually develops links between contexts and content.

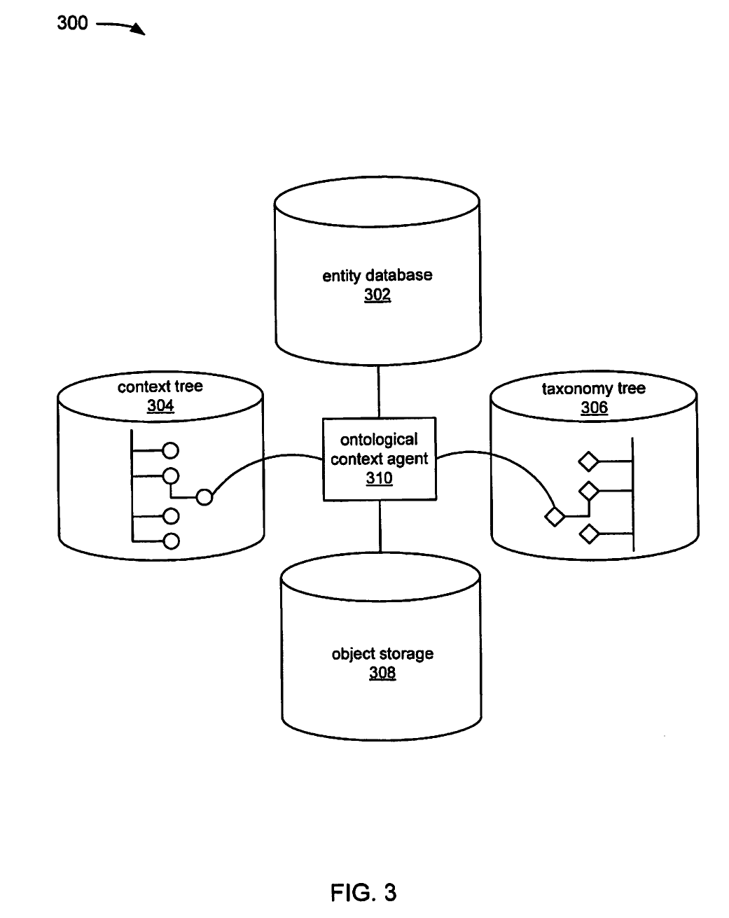

FIG. 3 includes entity database 302, context tree 304, taxonomy tree 306, object storage 308, and ontological context agent 310.

In the example of FIG. 3, the entity database 302 includes identifiers for one or more entities, e.g. employees of a business organization or other business organizations. The database can store records of the entities to use in relating the entities to objects and contexts. The entities produce new objects or modify existing objects. Such entities transmit and receive objects, collaborating with each other to further a business purpose.

In the example of FIG. 3, the context tree 304 includes one or more nodes identifying and relating contexts in the business organization. A context tree can have only one node, representing a single context. Typically, a context tree includes multiple nodes. The nodes can be arranged hierarchically, with contexts and sub-contexts representing aspects of the projects. A parent node of a child node can represent a context that has a sub-context. In a non-limiting example, financing of a new construction could be a sub-context of a context associated with the new construction as a whole.

In the example of FIG. 3, the taxonomy tree 306 includes one or more nodes relating local, national and international terms. The taxonomy tree can be expressed hierarchically. Nodes in the tree can represent various terms used in different localities or among different groups such as is done with folksonomies. As entities communicate using various terms, the taxonomy tree grows by adding the terms that were not previously included in the tree. In a non-limiting example, an individual is titled with “CEO,” but is referred to as “boss,” the term boss is associated with the title “CEO,” and in future references the taxonomy can be used to identify the various terms.

In the example of FIG. 3, the object storage 308 can be a database or other data repository of objects. The objects can be documents, communications, meta-data, or any known or convenient object directed to a business purpose. Objects can be directly stored in the object storage 308, or alternatively, the objects can be linked using the object storage. In a non-limiting example, the object storage 308 is a database including links to the objects stored in a mass storage device.

In the example of FIG. 3, in operation, the ontological context agent 310 receives an object to be stored in object storage 308 in association with a context of the context tree 304. The object can be an object that was transmitted by an entity to another entity. The ontological context agent 310 identifies an entity associated with the object using the taxonomy tree 306. Alternatively, the ontological context agent can inspect the object for an identifier of the entity within the object. The ontological context agent 310 associates the object with a first context node associated with a context of the context tree 304. The ontological context agent 310 stores the object in the object storage 308, such as directly into a database, or can store the object into a storage location and create a link in a database in the object storage 308.

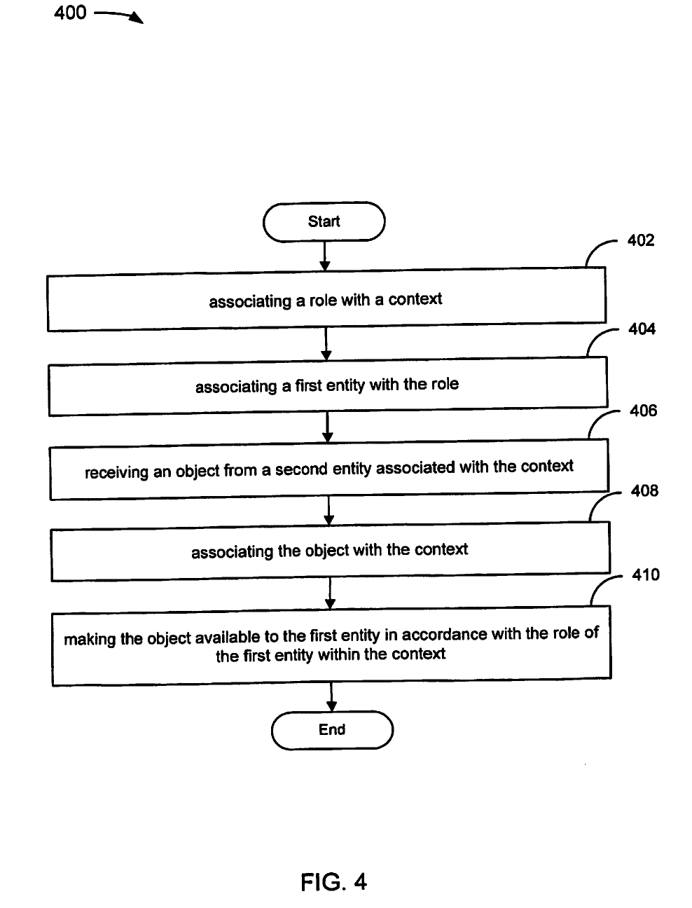

FIG. 4 depicts a flowchart of an example of a method for making an object available to an entity having a role in a context without a request from the entity for the object. The method is organized as a sequence of modules in the flowchart 400. However, it should be understood that these and modules associated with other methods described herein may be reordered for parallel execution or into different sequences of modules.

In the example of FIG. 4, the flowchart starts at module 402 with associating a role with a context. The role can be that of an entity performed to further a business purpose of a context. Typically, an entity is given a title, however, the entity can perform a narrower or different role from the title the entity is given. In a non-limiting example, an entity, such as a “programmer” could perform a role could of “project manager” tasked with the purpose of producing a final product.

In the example of FIG. 4, the flowchart continues to module 404 with associating a first entity with the role. The entity is associated with the role and is also associated with the context. In continuing the non-limiting example, the role is that of project manager, and an individual having the title of “Programmer II” is given the role of project manager in the context.

In the example of FIG. 4, the flowchart continues to module 406 with receiving an object from a second entity associated with the context. The object could be a communication sent by the project manager to another entity associated with the context. The communication could be, for example, an email. The object is received and handled by an ontological context agent for storage in the associated context.

In the example of FIG. 4, the flowchart continues to module 408 with associating the object with the context. The association of the object can be by a meta-data unit, a link, a record in a database, or any known or convenient manner of relating the object to the context with which it is associated.

In the example of FIG. 4, the flowchart continues to module 410 with making the object available to the first entity in accordance with a role of the first entity within the context. Typically, the object itself is not transmitted. An ontological context agent could generate a communication to the first entity including a link to the object. Alternatively, by changing permissions for the object, the first entity is allowed to access the object, and the object may be automatically provided to the entity along with other objects already available to the entity. Having made the object available to the first entity, the flowchart terminates.

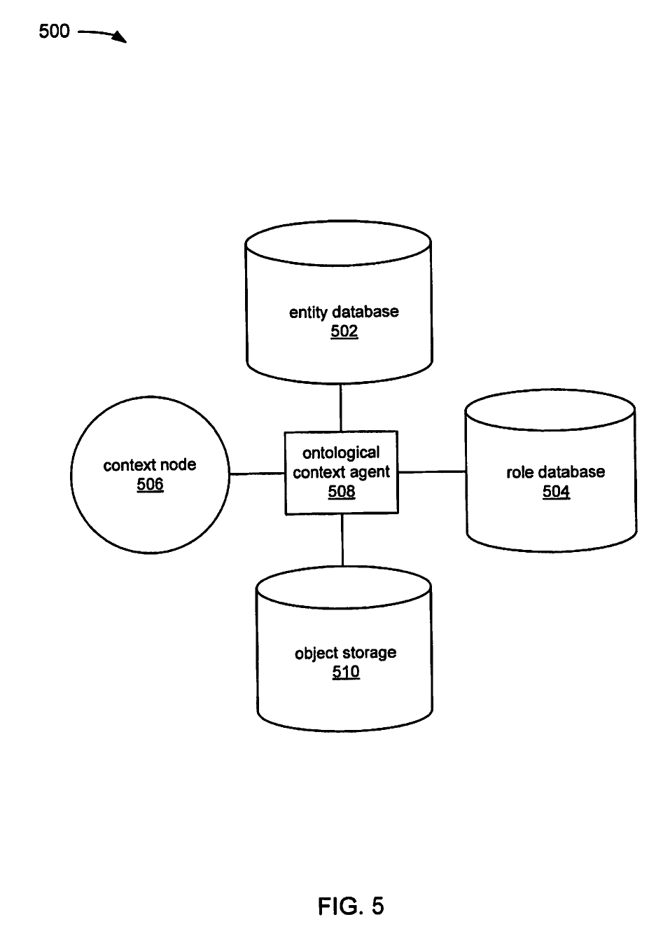

FIG. 5 depicts a diagram of an example of an ontological context agent coupled to a context node, an entity database, a role database, and object storage. FIG. 5 includes entity database 502, role database 504, context node 506, agent 508, and object storage 510.

In the example of FIG. 5, the entity database 502 stores records of entities such as name and contact information. The entities included can be people, software executing on hardware, or corporations represented by individuals, or any other known or convenient entity having a business purpose. The database can store records relating the entities to the information describing the entities. The database structure can be designed around any known or convenient schema relating the entities to the information describing the entities.

In the example of FIG. 5, the role database 504 stores records of roles performed by entities. The roles included relate to entities, such as persons who perform the roles in furtherance of the business purpose of a context. The records of the roles can be constructed within any known or convenient database including. The role database 504 can includes one or more links to contexts indicating the entities that are performing the roles in furtherance of the business purpose of the context. Such links can be created to identify the roles as related to the contexts.

In the example of FIG. 5, the context node 506 is directed to a business purpose and is represented as a single node, but could be a part of a larger context tree representing a hierarchical structure of business projects within an organization. Where the context node 506 is a child node of a parent context node, the child node can be a sub-context of the parent node. Alternatively if the context node 506 is a parent node, child nodes can represent sub-contexts of the context node 506. The context node 506 can be linked to other contexts, entities, roles indicating relationships of entities, contexts, and roles to the context node 506.

In the example of FIG. 5, the ontological context agent 508 acts on behalf of the context; that is to say the ontological context agent 508 is a surrogate of a context. The ontological context agent can communicate objects, receive objects, link entities to contexts, and perform other known or convenient tasks with entities, objects, roles and contexts. The ontological context agent can operate with other ontological context agents. Such ontological context agents operate to further one or more business purposes of the contexts with which the ontological context agents are associated.

In the example of FIG. 5, in operation, the ontological context agent 510 receives an object associated with an entity. The object can be created by an entity in furtherance of a business purpose of the context. The ontological context agent 508 identifies a role from the role database 504 for the entity relative to the context. The role is performed by the entity to further the business purpose of the context, and can bear a name different from the title which the agent is given. The ontological context agent 510 creates an association between the entity and the role and stores the association in the context node 506, such as by creating a link or storing a record in a database. The ontological context agent 510 stores the object in the object storage 510 as associated with the role and with the context node 506. The object can include an association identifying the entity, or alternatively, the association can be reflected in a database entry. In a non-limiting example, such an association can be a link stored in a database, or can be a meta-data record of the association.

In the non-limiting example, the context could have the business purpose of hiring a new employee, and the object could be a document detailing a background investigation of the employee. The entity could be a hiring manager, and the role performed could be that of screener. Such an entity could be identified and automatically associated with the role. The role could be automatically associated with the object. Any other entities associated with the context, such as a recruiter could be automatically provided the object, so long as the other entities have sufficient security permission to view the object.

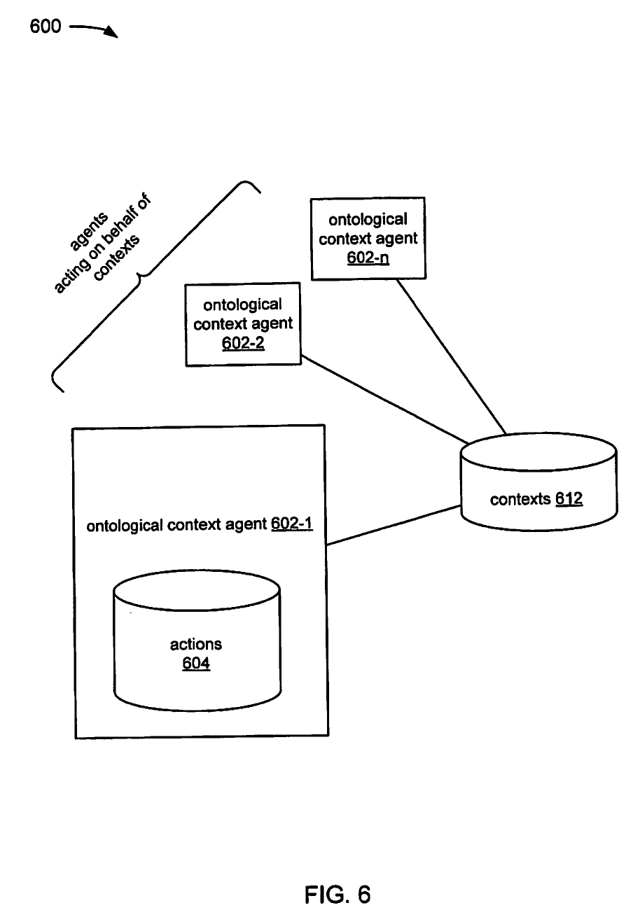

FIG. 6 depicts a diagram of an example of a plurality of ontological context agents acting on behalf of contexts. FIG. 6 includes ontological context agent 602-1, ontological context agent 602-2, ontological context agent 602-n (collectively ontological context agents 602), taxonomies 606, roles 608, entities 610, contexts 612, and objects 614. Ontological context agent 602-1 includes actions 604.

In the example of FIG. 6, the ontological context agents 602 are software agents executing on hardware in accordance with instructions directing the agents to further the business purposes of the contexts with which they are associated. The ontological context agents 602 perform actions on behalf of the contexts 612.

In the example of FIG. 6, the actions 604 are executable tasks which each of agents 602 can perform on behalf of the contexts with which the agents 602 are associated. The actions can be instructions coded in, e.g. the extensible markup language (XML). The actions 604 can a database to store a record, delete a record, modify a record and perform any known or convenient task. Such creation and modification of records can be used to create or delete links between an object and a role, a context and an object, an entity and a context, or any known or convenient link.

In the example of FIG. 6, the contexts 612 represent business purposes and all related content, roles and responsibilities, and assignments of people to roles in the context. One or more contexts are included in a business organization.

In the example of FIG. 6, in operation, the ontological context agents 602 receive objects from entities associated with the contexts 612. The ontological context agents 602 store objects and link the objects to one or more contexts. The objects are made available to one or more entities associated with the contexts included in the contexts 612. Each of the ontological context agents 602 executes actions to link objects, roles, and entities together with relevant contexts. Entities associated with the contexts 612 can automatically view the objects assuming the entities have sufficient security clearance.

In a non-limiting example, a context associated with the agent 602-1 is a parent context to the context associated with the agent 602-2. An object is associated with a context associated with ontological context agent 602-1. As the context associated with the ontological context agent 602-1 is a child of the context associated with the ontological context agent 602-2, the object can be relevant to the context associated with the context associated with the ontological context agent 602-2. The ontological context agent 602-1 thus creates a link to the context associated with the context associated with the ontological context agent 602-2. Entities associated with the context associated with the ontological context agent 602-2 are now able to view the object, and can be automatically provided the object.

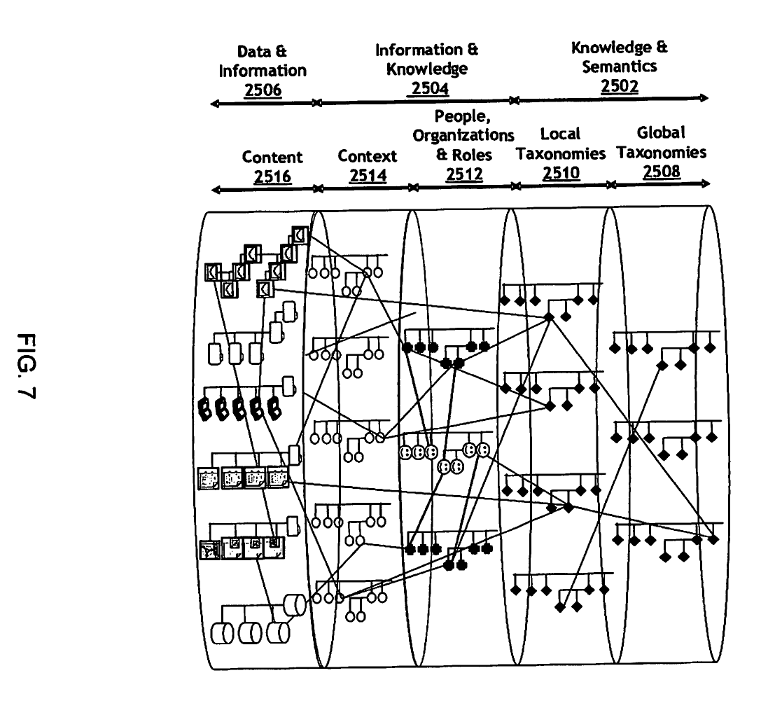

FIG. 7 depicts a diagram 700 of an example of an ontological representation of knowledge of a business organization. The diagram 700 includes taxonomies, roles, people, and content. Such a representation graphically depicts links between objects, roles, people and taxonomies.

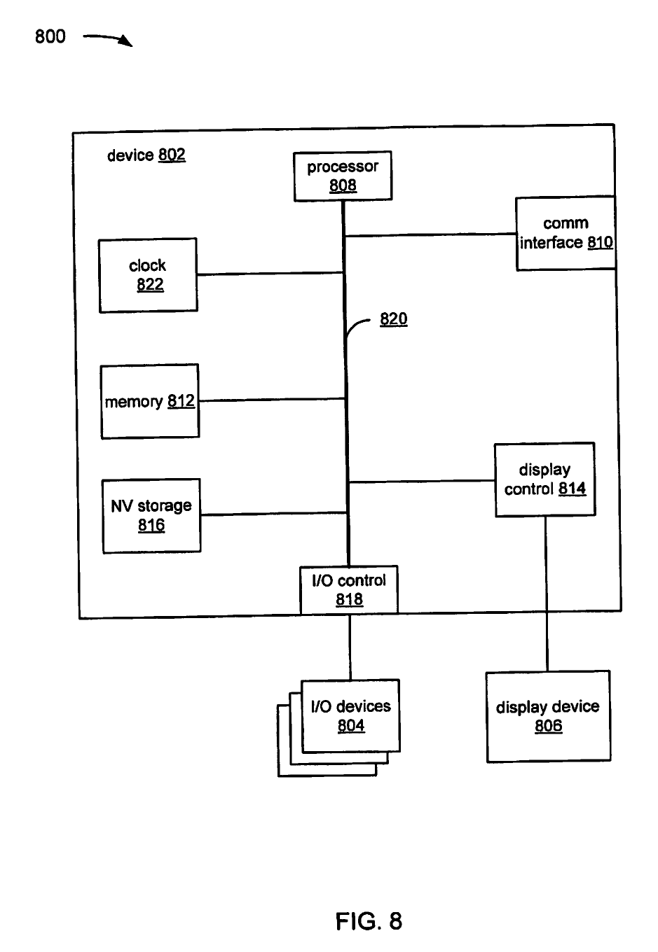

FIG. 8 depicts a diagram of an example of a computing system typical of any one of the computing systems discussed herein. The system 800 may be a conventional computer system that can be used as a client computer system, such as a wireless client or a workstation, or a server computer system. The system 800 includes a device 802, I/O devices 804, and a display device 806. The device 802 includes a processor 808, a communications interface 810, memory 812, display controller 814, non-volatile storage 816, I/O controller 818, clock 822. The device 802 may be coupled to or include the I/O devices 804 and the display device 806.

The device 802 interfaces to external systems through the communications interface 810, which may include a modem or network interface. It will be appreciated that the communications interface 810 can be considered to be part of the system 800 or a part of the device 802. The communications interface 810 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 808 may be, for example, a conventional microprocessor such as an Intel Pentium microprocessor or Motorola power PC microprocessor. The memory 812 is coupled to the processor 808 by a bus 820. The memory 812 can be Dynamic Random Access Memory (DRAM) and can also include Static RAM (SRAM). The bus 820 couples the processor 808 to the memory 812, also to the non-volatile storage 816, to the display controller 814, and to the I/O controller 818.

The I/O devices 804 can include a keyboard, disk drives, printers, a scanner, and other input and output devices, including a mouse or other pointing device. The display controller 814 may control in the conventional manner a display on the display device 806, which can be, for example, a cathode ray tube (CRT) or liquid crystal display (LCD). The display controller 814 and the I/O controller 818 can be implemented with conventional well known technology.

The non-volatile storage 816 is often a magnetic hard disk, flash memory, an optical disk, or another form of storage for large amounts of data. Some of this data is often written, by a direct memory access process, into memory 812 during execution of software in the device 802. One of skill in the art will immediately recognize that the terms “machine-readable medium” or “computer-readable medium” includes any type of storage device that is accessible by the processor 808.

Clock 822 can be any kind of oscillating circuit creating an electrical signal with a precise frequency. In a non-limiting example, clock 822 could be a crystal oscillator using the mechanical resonance of vibrating crystal to generate the electrical signal.

The system 800 is one example of many possible computer systems which have different architectures. For example, personal computers based on an Intel microprocessor often have multiple buses, one of which can be an I/O bus for the peripherals and one that directly connects the processor 808 and the memory 812 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 812 for execution by the processor 808. A Web TV system, which is known in the art, is also considered to be a computer system, but it may lack some of the features shown in FIG. 8, such as certain input or output devices. A typical computer system will usually include at least a processor, memory, and a bus coupling the memory to the processor.

In addition, the system 800 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 816 and causes the processor 808 to execute the various acts required by the operating system to input and output data and to store data in memory, including storing files on the non-volatile storage 816.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a context tree including a plurality of context nodes;
object storage including a plurality of objects, wherein each object is associated with a context node;
an entity database;
a taxonomy tree;
an ontological context agent coupled to the context tree, the object storage, the entity identification database, and the taxonomy tree;
wherein, in operation,
the ontological context agent receives an object;
the ontological context agent identifies an entity associated with the object using the taxonomy tree, wherein, the entity has an associated entry in the entity database;
the ontological context agent associates the entity in the entity database with the object;
the ontological context agent associates with the object, a first context node of the context tree, in which the entity has a role;
the ontological context agent stores the object in the object storage;
wherein, the object is associated with a second context node, in which the entity has no role, of the context tree, but the object is a single entry in the object storage.

2. The system of claim 1 further comprising a roles database wherein the ontological context agent associates the entity with the role in the context from the role definition database.

3. The system of claim 1 wherein the object is automatically provided to a second entity having a need to know level of security within the context.

4. The system of claim 1 wherein the ontological context agent provides the object to one or more entities because the entities perform roles in the context.

5. The system of claim 1 wherein a link between the context and the object is saved as a record in a database identifying the object as associated with the context.

6. The system of claim 1 wherein the context is a child context linked to a parent context, and entities associated with the parent context are provided access to the object.

7. The system of claim 1 wherein the context is a parent context and is linked to one or more child contexts and the entity is provided access to one or more objects in the one or more child contexts.

8. The system of claim 1 further comprising receiving a modification to the object from the entity and notifying one or more entities associated with the context that the object has been updated.

9. The system of claim 1 wherein the context is identified in the object by the entity.

10. The system of claim 1 further comprising an authorization module used by the ontological context agent to identify objects to provide to an entity having a need to know of the objects derived from a law.

11. The system of claim 1 wherein the object is an attachment of an email and the sender of the email is the entity, and the email is automatically made available to one or more entities associated with the context.

12. A method comprising:
associating a role with a context;
associating a first entity with the role;
receiving an object from a second entity associated with the context;
associating the object with the context;
making the object available to the first entity in accordance with the role of the first entity within the context.

13. The method of claim 12 wherein authority of the first entity to view the object is verified prior to making the object available to the first entity.

14. The method of claim 12 wherein the object is associated with the context by creating a link between the object and the context as a record in a database.

15. The method of claim 12 wherein the role of the first entity is identified by searching a taxonomy tree for the role.

16. The method of claim 12 wherein the object is received from the second entity via an email and the object is associated with the context by an identifier for the context included in the email.

17. A system comprising:
a context node;
an entity database;
a role database;
object storage including a plurality of objects, wherein each object is associated with the context node;
an ontological context agent coupled to the context node, the object storage, the role database, and the entity database;
wherein, in operation,
the ontological context agent receives an object associated with a context associated with the context node;
the ontological context agent identifies a role from the role database relative to the context;
the ontological context agent identifies an entity associated with the role;
the ontological context agent stores the object in the object storage in association with the context;
the ontological context agent makes the object available to the entity in accordance with the role of the entity to the context;
the ontological context agent makes the object available to the entity in accordance with the role of the entity to the context.

18. The system of claim 17 further comprising a second ontological context agent associated with a second context node, wherein the second ontological context agent links the object to the second context node for access by one or more entities associated with the second context node without reproducing the object.

19. The system of claim 17 further comprising a taxonomy tree wherein the taxonomy tree includes one or more nodes identifying common names for roles performed by the entity.

20. The system of claim 17 wherein the association between the entity and the role is created as a meta-data record linking the entity and the role and stored in association with the context.
